(19) United States
(12) Patent Application Publication
(10) Pub. No.: US 2011/0080289 A1
(43) Pub. Date: Apr. 7, 2011

(54) OUTPUT DEVICE DETECTION

(75) Inventor: Wayne Christopher Minton, Lund (SE)

(73) Assignee: SONY ERICSSON MOBILE COMMUNICATIONS AB, Lund (SE)

(21) Appl. No.: 12/603,844

(22) Filed: Oct. 22, 2009

Related U.S. Application Data
(60) Provisional application No. 61/248,630, filed on Oct. 5, 2009.

(51) Int. Cl. G08B 23/00; G10L 17/00

(52) U.S. Cl. 340/573.1; 704/246; 704/E17.001

(57) ABSTRACT

A device may include a sensor configured to detect when a user is wearing or holding the device. The device may also include a display and a communication interface. The communication interface may be configured to forward an indication to a media playing device when the user is wearing or holding the device and receive content from the media playing device, where the content is received in response to the indication that the user is wearing or holding the device. The communication interface may also output the content to the display.

### RELATED APPLICATION

This application claims priority under 35 U.S.C. § 119 based on U.S. Provisional Application No. 61/248,630, filed Oct. 5, 2009, the disclosure of which is hereby incorporated herein by reference.

### TECHNICAL FIELD OF THE INVENTION

The invention relates generally to user devices and, more particularly, to selectively outputting content to display devices.

### DESCRIPTION OF RELATED ART

Content or media playing devices, such as portable media players, are becoming more common. For example, cellular telephones that include music players, video players, etc., are often used during the course of the day to play various content/media. These devices typically include a small display screen that allows the user to view the content.

### SUMMARY

According to one aspect, a device may be provided. The device includes at least one sensor configured to detect when a user is wearing or holding the device. The device also includes a display and a communication interface configured to forward an indication to a media playing device when the user is wearing or holding the device, receive content from the media playing device, the content being received in response to the indication that the user is wearing or holding the device, and output the content to the display.

Additionally, the at least one sensor may be configured to detect a change in an electrical property, pressure or temperature.

Additionally, the at least one sensor may be configured to detect a change in electrical capacitance, resistance or inductance.

Additionally, the at least one sensor may comprise a first temperature sensor and a second temperature sensor. The device may further comprise processing logic configured to detect a difference in temperature between the first and second temperature sensors, and determine that the user is wearing or holding the device when the difference meets a threshold value.

Additionally, the at least one sensor may be located in a nose pad, frame temple or nose bridge of a pair of video glasses.

Additionally, the device may comprise a pair of video glasses, a pair of goggles, a face shield, a watch, a bracelet or a clip.

Additionally, the device may further comprise processing logic configured to detect when the device is no longer being worn or held by the user, and forward information to the media playing device when the device is no longer being worn or held by the user.

Additionally, the device may further comprise processing logic configured to receive voice input from the user, and identify the content based on the voice input.

Additionally, when forwarding the indication, the communication interface may be configured to forward the indication via radio frequency communications.

Additionally, when receiving content, the communication interface may be configured to receive the content via radio frequency communications.

According to another aspect, a method is provided. The method includes receiving voice input from a user, identifying content to be played based on the voice input and receiving input from an output device, the input indicating that the output device is being worn or held by the user. The method also includes outputting, based on the received input, content to the output device.

Additionally, the receiving input from the output device comprises receiving input identifying that one of a pair of glasses, goggles, watch or bracelet is being worn.

Additionally, the method may further comprise detecting, based on one or more sensors located on the output device, at least one of a temperature, pressure, or an electrical characteristic.

Additionally, the method may further comprise determining that the output device is being worn or held based on the detecting.

Additionally, the receiving input may comprise receiving input from the output device via radio frequency (RF) communications, and the outputting content may comprise outputting content to the output device via RF communications.

According to a further aspect, a system including a plurality of output devices and logic is provided. The logic is configured to identify an input from a first one of the plurality of output devices, the input indicating that the first output device is being worn or held, and forward media to the first output device.

Additionally, the logic may be further configured to receive voice input from a user identifying a media file, and identify the media file based on the voice input.

Additionally, when identifying an input, the first output device may be configured to detect one of a resistance, capacitance, pressure or temperature condition associated with the first output device.

Additionally, the plurality of output devices may comprise at least two of a pair of video glasses, a pair of video goggles, an interactive watch, an interactive bracelet or a display screen.

Additionally, the first output device may comprise a pair of video glasses and a second one of the plurality of output devices may comprise a liquid crystal or light emitting diode based display screen.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 illustrates an exemplary network in which systems and methods described herein may be implemented;

FIG. 2 illustrates an exemplary configuration of the user device, output devices or service provider of FIG. 1;

FIGS. 3A-3C are diagrams of output devices consistent with exemplary implementations; and

FIG. 4 is a flow diagram illustrating exemplary processing by the devices in FIG. 1.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

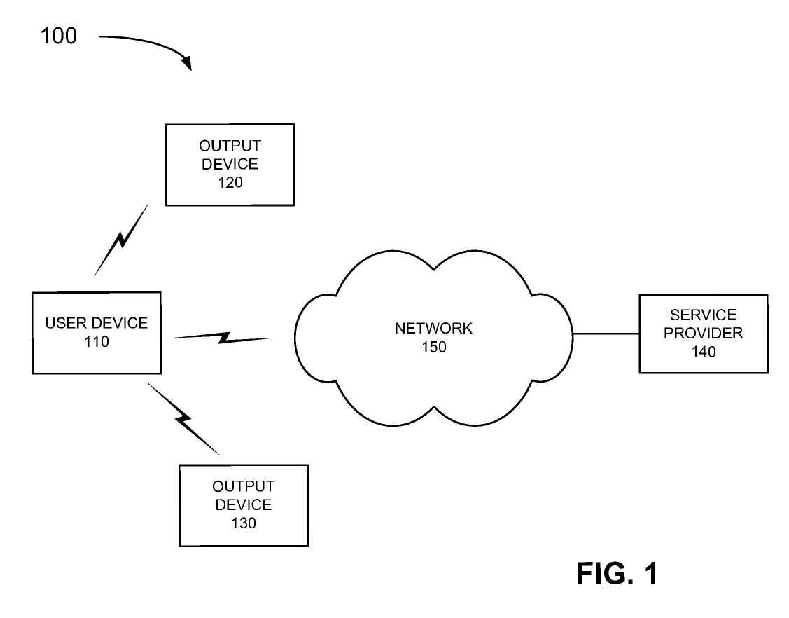

FIG. 1 is a diagram of an exemplary network 100 in which systems and methods described herein may be implemented. Referring to FIG. 1, network 100 may include user device 110, output devices 120 and 130, service provider 140 and network 150. User device 110 may include any type of processing device which is able to communicate with other devices in network 100. For example, user device 110 may include any type of device that is capable of transmitting and receiving data (e.g., voice, text, images, multi-media data) to and/or from other devices or networks (e.g., output devices 120 and 130, service provider 140, network 150).

In an exemplary implementation, user device 110 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

In an alternative implementation, user device 110 may include any media-playing device, such as personal computer (PC), a laptop computer, a PDA, a web-based appliance, a music or video playing device (e.g., an MPEG audio and/or video player), a video game playing device, a camera, a GPS device, etc. In each case, user device 110 may communicate with output devices, such as output devices 120 and 130, via wired, wireless, or optical connections to selectively output media for display, as described in detail below.

Output devices 120 and 130 may each include any device that is able to output/display various media, such as a television, a monitor, a PC, laptop computer, a PDA, a web-based appliance, a mobile terminal, etc. Output devices 120 and 130 may also include portable devices that may be worn or carried by users. For example, output devices 120 and 130 may include interactive video glasses, watches, bracelets, clips, etc., that may be used to play or display media (e.g., multi-media content). Output devices 120 and 130 may also include display devices, such as liquid crystal displays (LCDs), light emitting diode (LED) based displays, etc., that display media (e.g., multi-media content). In some instances, output devices 120 and/or 130 may be carried by users or may be stationary devices, as described in detail below.

Service provider 140 may include one or more computing devices, servers and/or backend systems that are able to connect to network 150 and transmit and/or receive information via network 150. In an exemplary implementation, service provider 140 may provide multi-media information, such as television shows, movies, sporting events, podcasts or other media presentations to user device 110 for output to a user/viewer.

Network 150 may include one or more wired, wireless and/or optical networks that are capable of receiving and transmitting data, voice and/or video signals, including multi-media signals that include voice, data and video information. For example, network 150 may include one or more public switched telephone networks (PSTNs) or other type of switched network. Network 150 may also include one or more wireless networks and may include a number of transmission towers for receiving wireless signals and forwarding the wireless signals toward the intended destinations. Network 150 may further include one or more satellite networks, one or more packet switched networks, such as an Internet protocol (IP) based network, a local area network (LAN), a wide area network (WAN), a personal area network (PAN) (e.g., a wireless PAN), an intranet, the Internet, or another type of network that is capable of transmitting data.

The configuration illustrated in FIG. 1 is provided for simplicity. It should be understood that a typical network may include more or fewer devices than illustrated in FIG. 1. For example, network 100 may include additional elements, such as additional user devices and output devices. Network 100 may also include switches, gateways, routers, backend systems, etc., that aid in routing information, such as media streams between various components illustrated in FIG. 1. In addition, although user device 110 and output devices 120 and 130 are shown as separate devices in FIG. 1, in other implementations, the functions performed by two or more of these devices may be performed by a single device or platform.

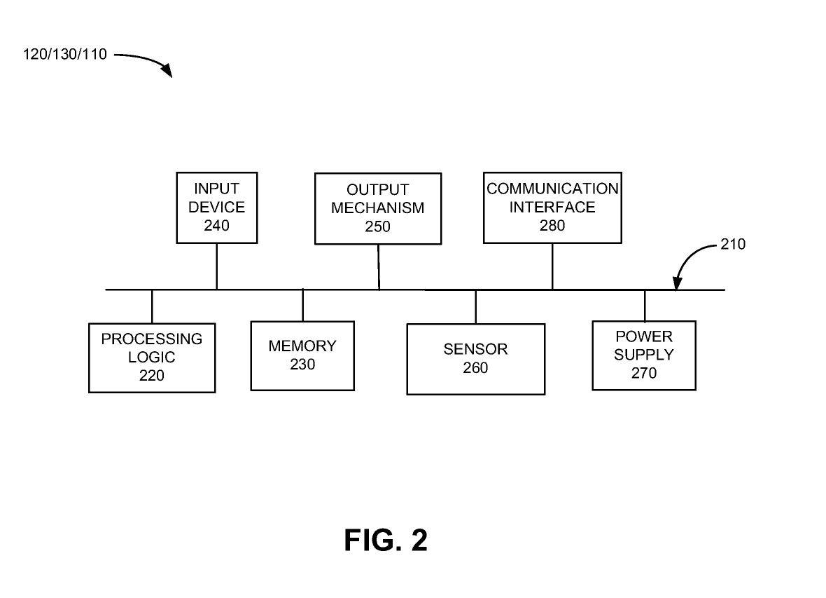

FIG. 2 illustrates an exemplary configuration of output device 120. Output device 130, user device 110 and service provider 140 may be configured in a similar manner. Referring to FIG. 2, output device 120 may include a bus 210, processing logic 220, a memory 230, an input device 240, an output mechanism 250, a sensor 260, a power supply 270 and a communication interface 280. Bus 210 may include a path that permits communication among the elements of output device 110.

Processing logic 220 may include a processor, microprocessor, an application specific integrated circuit (ASIC), field programmable gate array (FPGA) or the like. Processing logic 220 may execute software programs or data structures to control operation of output device 120.

Memory 230 may include a random access memory (RAM) or another type of dynamic storage device that stores information and instructions for execution by processing logic 220; a read only memory (ROM) or another type of static storage device that stores static information and instructions for use by processing logic 220. Memory 230 may further include a solid state drive (SDD), a magnetic and/or optical recording medium (e.g., a hard disk) and its corresponding drive. Instructions used by processing logic 220 may also, or alternatively, be stored in another type of computer-readable medium accessible by processing logic 220. A computer-readable medium may include one or more memory devices.

Input device 240 may include any mechanism that permits a user to input information to output device 120, such as a keyboard, a keypad, a mouse, a pen, a microphone, a display (e.g. a touch screen), voice recognition and/or biometric mechanisms, etc. Input device 240 may also include mechanisms for receiving input via another device, such as user device 110. For example, input device 240 may receive commands from another device (e.g., user device 110) via radio frequency (RF) signals.

Output mechanism 250 may include one or more mechanisms that outputs information to a user, including a display, a printer, a speaker, etc. In an exemplary implementation, output mechanism 250 may be associated with a display that may be worn or carried. For example, output mechanism 250 may include a display associated with wearable video glasses, a watch, a bracelet, a clip, etc., as described in more detail below. In other instances, output mechanism 250 may include a liquid crystal display (LCD), a light emitting diode (LED) based screen or another type of screen or display.

Sensor 260 may include one or more sensors used to detect or sense various operational conditions associated with output device 120. For example, sensor 260 may include one or more mechanisms used to determine whether output device 120 is being worn or held. As an example, sensor 260 may include a pressure sensitive material or component that registers an input based on pressure or contact. Alternatively, sensor 260 may include a material or component that registers an input based on electrical characteristics or properties, such as a change in resistance, capacitance or inductance in a manner similar to that used in touch screens. In still other alternatives, sensor 260 may include a material that registers an input based on other types of user contact. For example, sensor 260 may include one or more temperature sensors used to detect contact with a human based on the sensed temperature or difference between temperature sensed by different sensors, as described in detail below.

In each case, sensor 260 may include a component or material that detects that a user is wearing or holding output device 120. For example, as discussed above, in one implementation, output device 120 may include a pair of video glasses that are used to display media to a user. In such an instance, sensor 260 may include one or more sensors to detect that the user is wearing the video glasses. As another example, output device 120 may include a portable LCD screen. In such an instance, sensor 260 may include one or more sensors to detect that the user is holding or carrying output device 120.

Power supply 270 may include one or more batteries and/or other power source components used to supply power to components of output device 120.

Communication interface 280 may include any transceiver-like mechanism that output device 120 may use to communicate with other devices (e.g., user device 110, output device 130, service provider 140). For example, communication interface 260 may include mechanisms for communicating with user device 110 and/or service provider 140 via wired, wireless or optical mechanisms. For example, communication interface 280 may include one or more radio frequency (RF) transmitters, receivers and/or transceivers and one or more antennas for transmitting and receiving RF data, such as RF data from user device 110 or RF data via network 150. Communication interface 280 may also include a modem or an Ethernet interface to a LAN or other mechanisms for communicating via a network, such as network 150 or another network (e.g., a personal area network) via which output device 120 communicates with other devices/systems.

The exemplary configuration illustrated in FIG. 2 is provided for simplicity. It should be understood that output devices 120 and 130, user device 110 and/or service provider 140 may include more or fewer devices than illustrated in FIG. 2. For example, various modulating, demodulating, coding and/or decoding components, or other components may be included in one or more of output devices 120 and 130, user device 110 and service provider 140.

Output device 120, output device 130 and user device 110 may perform processing associated with, for example, displaying/playing media to a user. Output device 120, output device 130 and user device 110 may perform these operations in response to their respective processing logic 220 and/or another device executing sequences of instructions contained in a computer-readable medium, such as their respective memories 230. Execution of sequences of instructions contained in memory 230 may cause processing logic 220 and/or another device to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

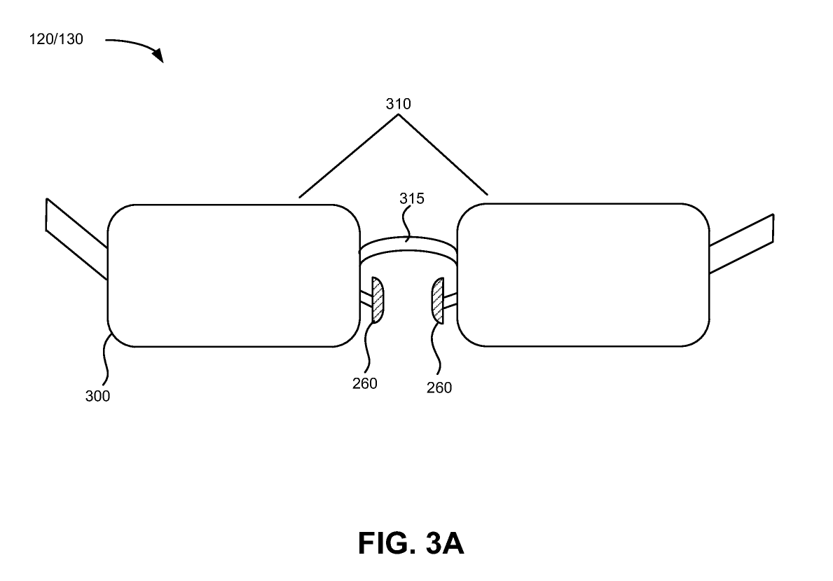

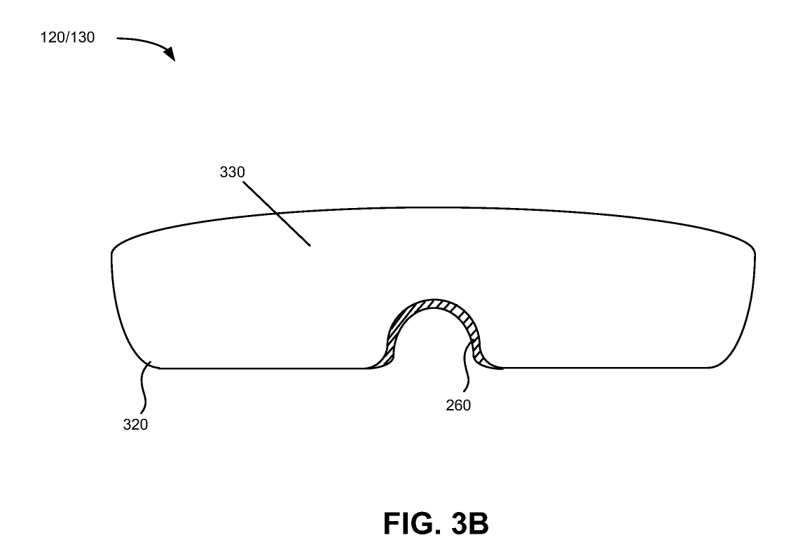

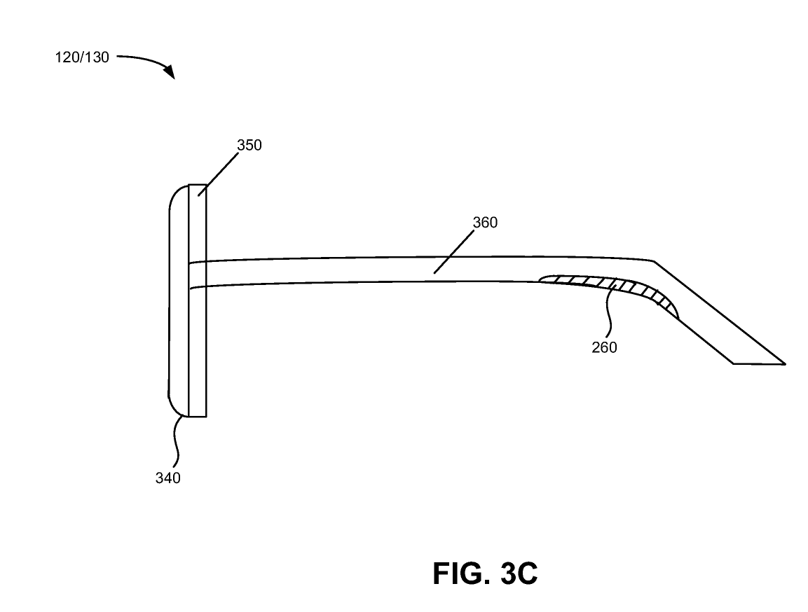

FIG. 3A is a diagram of output device 120 consistent with an exemplary implementation. Referring to FIG. 3A, as described above, output device 120 may include a pair of video glasses 300 that are used to play and/or display media to a party wearing video glasses 300. For example, video glasses 300 may include members 310, also referred to herein as displays 310, that allow a user to view video content. In some instances, a single member/display 310 may be used.

Video glasses 300 may also include sensors 260 located in “nose pads” of video glasses 300. As discussed above, sensors 260 may include any type sensor used to detect that a user is wearing video glasses 300. For example, sensors 260 may be resistive sensors, capacitive sensors, pressure-sensitive sensors, etc., that register an input based on changes in electrical characteristics (e.g., resistance, capacitance, inductance) or pressure based on contact with a portion of a user's face (e.g., nose). It should be understood that sensors 260 may be located in other portions of video glasses 300. For example, sensors 260 may be located on portion 315 (e.g., a bridge component) of video glasses 300. In other instances, output device 120/130 have other shapes/forms.

For example, FIG. 3B is a diagram of output device 120 in accordance with another exemplary implementation. Referring to FIG. 3B, output device 120 may include a pair of video glasses 320 that have a different form and sensor configuration than output device 120 illustrated in FIG. 3A. For example, output device 120 may include a pair of video glasses 320 that have a “wrap around” style. Video glasses 320 may include member 330, also referred to herein as display 330, that allows a user to view video content. Video glasses 320 may also include sensor 260 located on the bridge portion of video glasses 320, as illustrated in FIG. 3B. That is, sensor 260 may include one or more sensors located in the portion of video glasses 320 where the user's nose contacts video glasses 320 when the user is wearing video glasses 320. In this case, sensor 260 may include any type of sensor similar to that described above with respect to FIG. 3A. That is, sensor 260 may include a component or material that detects changes in resistance, capacitance, etc., or detects pressure or temperature. In each case, sensor 260 may register an input when a user is wearing video glasses 320 based on, for example, contact or close proximity with a portion of a user's face (e.g., nose).

FIG. 3C is a diagram of output device 120 in an accordance with another exemplary implementation. Referring to FIG. 3C, output device 120 may include a pair of video glasses 340 having a different sensor configuration. For example, video glasses 340 may include a display 350 that may include one or more screens similar to the designs illustrated in FIGS. 3A and 3B. Video glasses 340 may also include side pieces 360 (only one side piece 360 is visible in the side view illustrated in FIG. 3C). Side piece 360 (also referred to as temples or armatures 360) may include sensors 260 located in the portion of side pieces 360 that contact a user's ear. Similar to the description above, sensor 260 may include any type of sensor similar to that described above (e.g., resistive sensor, capacitive sensor, pressure-sensitive sensor, temperature sensor, etc.) that registers an input based on a contact or close proximity with a portion of a user's face (e.g., ear).

In the implementation illustrated in FIG. 3C, sensor 260 may include multiple sensors and/or a component or material that is distributed in an area in which the user's ear is expected to contact. In one implementation, sensor 260 may include a first sensor located on one of side pieces/temples 360 and another sensor located on a portion of video glasses 340 that does not contact the user's face or ear when being worn. In such a case, if the temperature at the first sensor that contacts the user's ear is not within a predetermined value of the temperature of the second sensor that does not contact the user's face or ear, this may be used to indicate that video glasses 340 are being worn. That is, the temperature differential that is greater than a threshold is assumed to be caused by video glasses 340 being worn, and not by ambient heat that affects all portions of glasses 340 essentially equally.

The exemplary output devices and sensor configuration illustrated in FIGS. 3A-3C are provided for simplicity. In other implementations, other types of output devices and sensor configurations may be used. For example, an output device 120 may include a pair of goggles with a sensor 260 located at a top portion of the goggles contacting the user's head or face, a face shield with a display and a sensor 260 located in an upper portion of the face shield, etc.

In each case, sensors 260 may be strategically located to identify or register an input or measure a difference in conditions that may be used to indicate that a user is wearing video glasses 300/320/340.

In other implementations, output device 120 may be a bracelet, watch, clip or other wearable device. In such implementations, sensors 260 may be strategically located to detect whether the device is being worn. For example, if output device 120 includes a watch or bracelet, sensor 260 may be located on a strap or other portion of the watch/bracelet that contacts the user's skin or clothing when being worn.

As discussed above, in other implementations, output device 120 may be a device that is held by a user. In such implementations, sensor 260 may be located in portions of output device 120 that a user typically holds. For example, if output device 120 is a hand-held LCD output device, sensor 260 may be located along the sides where a user typically would grip the hand-held device.

In each case, sensor 260 may be strategically located to detect whether output device 120 is being worn or held. Such an indication may then be transmitted to and used by user device 110 to determine whether to output media to output device 120 or to another device/display, as described in detail below.

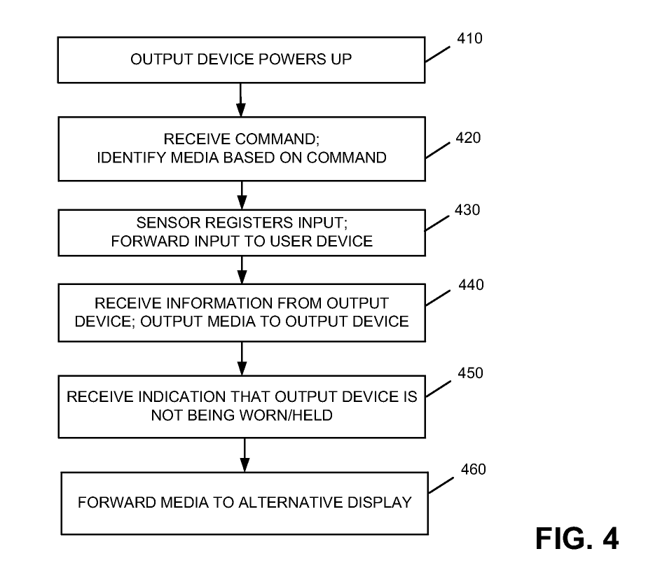

FIG. 4 is a flow diagram illustrating exemplary processing associated with selectively displaying or playing media on an output device. For this example, assume that user device 110 includes a wireless microphone (FIG. 2, input device 240) and that a user associated with user device 110 is wearing the wireless microphone clipped to his/her collar. Processing may begin when a user powers up output device 120 (act 410). For example, in this case, assume that output device 120 corresponds to wireless video glasses 300 described above with respect to FIG. 3A and that wireless video glasses 300 include a power on switch that has been turned on.

Further assume that the user has also powered up user device 110 and would like to play various media, such as a movie stored on user device 110 (e.g., in memory 230). In this example, also assume that user device 110 includes an LCD (e.g., output mechanism 250) that is integral with user device 110. That is, user device 110 may be a media playing device with a small (e.g., 3 inch) LCD screen.

User device 110 may receive a command or instruction to play particular content stored on user device 110 (act 420). For example, assume that the user of user device 110 provides a voice command, such as “play Citizen Kane.” Processing logic 220 on user device 110 may use voice recognition software stored on user device 110 (e.g., in memory 230) to identify the voice command. Alternatively, a user may access a menu showing stored content and use one or more control keys to request that user device 110 play a particular media file (e.g., a movie). In still other alternatives, processing logic 220 on output device 120 may be used to identify selected content. For example, the wireless microphone worn by the user may be associated with output device 120 and processing logic 220 on output device 120 may identify the selected command.

In each case, processing logic 220 in user device 110 may identify the appropriate media file that the user would like to play (act 420). Processing logic 220 may also identify the appropriate output device to play the media file.

For example, as discussed above, assume that the user is wearing video glasses 300 illustrated in FIG. 3A. In this case, sensors 260 located on, for example, the nose pads of video glasses 300 may detect that the user is wearing video glasses 300. For example, as described above, sensor 260 may sense a change in electrical capacitance or resistance when a user is wearing video glasses. Such a change may be registered by sensor 260 as an input. In other instances, sensor 260 may sense pressure. In these instances, when sensor 260 detects a pressure above a threshold value, sensor 260 may register an input. In still other instances, sensor 260 may include a first sensor located in an area that contacts a portion of the user's head/face when being worn and a second sensor located in an area that does not contact a user's head/face when video glasses 300 are being worn. As described above, in such instances, when the difference in temperature between the first and second sensors meets or exceeds a threshold, sensor 260 may register an input. In each case, sensor 260 may register an input when a user is wearing video glasses 300 (act 430).

Sensor 260 and/or processing logic 220 in output device 120 may forward the input to user device 110 (act 430). For example, processing logic 220 may receive the input from sensor 260 and forward the input, via communication interface 280, to user device 110. In an exemplary implementation, communication interface 280 may forward the indication to user device 110 wirelessly via RF communications (e.g., via a Bluetooth connection). Such wireless communications enable user device 110 and output device 120 to communicate without requiring a cord or other wired mechanism to be used to connect the two devices. This permits more freedom of movement of a user.

User device 110 may receive the indication that output device 120 is being worn (act 440). User device 110 may then wirelessly output the selected media to output device 120 (act 440). In this example, user device 110 may transmit, via RF communications, the movie Citizen Kane to video glasses 300. The user wearing video glasses 300 may then view the movie via displays 310.

In this manner, user device 110 may selectively forward content to an output device (e.g., output device 120 in this example) based on whether a user is wearing output device 120. In other implementations, if user device 110 does not receive an indication that output device 120 is being worn, user device 110 may output the content to another device.

For example, suppose that output device 130 is a hand-held gaming device that includes sensor 260 in areas where the user would grip the gaming device. In such an instance, output device 130 may send an indication to user device 110 indicating that the gaming device is being held. In this instance, user device 110 may output the media (e.g., the movie Citizen Kane in this example) to output device 130.

Referring back to FIG. 4, assume that the user takes off video glasses 300 and/or turns off video glasses 300. In this case, sensor 260 may forward an indication that video glasses 300 are no longer being worn. Processing logic 220 in user device 110 receives the indication that video glasses 300 are no longer being worn (act 450). Alternatively, a lack of a signal from output device 120 indicating that video glasses 300 are being worn may be used to indicate that the user has removed the video glasses 300.

Processing logic 220 may then output the media to an alternative output device/display (act 460). For example, processing logic 220 may output the media to output device 130, if output device 130 is being held/worn. If neither output device 120 or 130 is being held/worn, processing logic 220 may output the media to an integral display (e.g., output mechanism 250 on user device 110).

In this manner, user device 110 may interact with one or more output devices (e.g., output devices 120 and 130) to selectively output media to an appropriate output device/display.

In some implementations, user device 110 may output media to more than one device for simultaneous viewing. For example, selected media may be output to an integral display included on user device 110 and to one or more of output devices 120/130 for simultaneous viewing by more than one party.

In addition, in some implementations, a combination of different types of sensors 260 may be used to indicate that output device 120/130 is being held or worn. For example, in some instances, a first sensor 260 may include, for example, a pressure sensor and a second sensor 260 may be a resistive or a capacitive sensor, or may include multiple temperature sensors. In such implementations, when both types of sensors 260 indicate that output device 120/130 is being worn or held, output device 120/130 may forward the input indication to user device 110. This may help prevent user device 110 from transmitting media/content to output device 120/130 when a user is not actually wearing or holding output device 120/130. That is, in some instances a single sensor 260 may register an input based on output device 120/130 contacting a surface within a user's backpack, briefcase, etc. Using two different types of sensors 260 to indicate an input may help prevent user device 110 from inadvertently transmitting content for output on output device 120/130.

### CONCLUSION

Implementations described herein provide for selectively outputting content based on sensor information associated with an output device. Advantageously, this may allow content to be quickly outputted to an appropriate device with little to no human interaction.

The foregoing description of the embodiments of the invention provides illustration and description, but is not intended to be exhaustive or to limit the invention to the precise form disclosed. Modifications and variations are possible in light of the above teachings or may be acquired from practice of the invention.

For example, aspects have been described with respect to output devices (e.g., output devices 120 and 130) that are separate devices from user device 110. In other implementations, output devices 120 and 130 may be accessory display devices that are part of user device 110 and/or are intended to be used with user device 110.

In addition, aspects have been described mainly in the context of an output device that includes video glasses. It should be understood that other output devices that may be worn, carried or held may be used in other implementations. In still other implementations, a user device 110 may output content to a stationary or relatively stationary output device, such as a television or PC. In such implementations, if a larger output device/screen is available, user device 110 may detect the availability of such a device. For example, if a television or PC is turned on, user device 110 may identify such a device that may be included in a user's PAN. In these instances, user device 110 may automatically forward selected media to the largest or best output device based on the particular circumstances.

In other instances, user device 110 may select the appropriate output device based on the particular circumstances and/or availability. For example, if the user selected a video game for playing, user device 110 may automatically select an appropriate output device based on a user's predefined preferences with respect to playing the video game.

Further, while series of acts have been described with respect to FIG. 4, the order of the acts may be varied in other implementations consistent with the invention. Moreover, non-dependent acts may be performed in parallel.

It will also be apparent to one of ordinary skill in the art that aspects of the invention, as described above, may be implemented in cellular communication devices/systems, consumer electronic devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects described herein are not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
at least one sensor configured to detect when a user is wearing or holding the device;
a display; and
a communication interface configured to:
forward an indication to a media playing device when the user is wearing or holding the device,
receive content from the media playing device, the content being received in response to the indication that the user is wearing or holding the device, and
output the content to the display.

2. The device of claim 1, wherein the at least one sensor is configured to detect a change in an electrical property, pressure or temperature.

3. The device of claim 2, wherein the at least one sensor is configured to detect a change in electrical capacitance, resistance or inductance.

4. The device of claim 2, wherein the at least one sensor comprises a first temperature sensor and a second temperature sensor, the device further comprising:
processing logic configured to:
detect a difference in temperature between the first and second temperature sensors, and
determine that the user is wearing or holding the device when the difference meets a threshold value.

5. The device of claim 2, wherein the at least one sensor is located in a nose pad, frame temple or nose bridge of a pair of video glasses.

6. The device of claim 2, wherein the device comprise a pair of video glasses, a pair of goggles, a face shield, a watch, a bracelet or a clip.

7. The device of claim 1, further comprising:
processing logic configured to:
detect when the device is no longer being worn or held by the user, and
forward information to the media playing device when the device is no longer being worn or held by the user.

8. The device of claim 1, further comprising:
processing logic configured to:
receive voice input from the user, and
identify the content based on the voice input.

9. The device of claim 1, wherein when forwarding the indication, the communication interface is configured to forward the indication via radio frequency communications.

10. The device of claim 1, wherein when receiving content, the communication interface is configured to receive the content via radio frequency communications.

11. A method, comprising:
receiving voice input from a user;
identifying content to be played based on the voice input;
receiving input from an output device, the input indicating that the output device is being worn or held by the user; and
outputting, based on the received input, content to the output device.

12. The method of claim 11, wherein the receiving input from the output device comprises:
receiving input identifying that one of a pair of glasses, goggles, watch or bracelet is being worn.

13. The method of claim 11, further comprising:
detecting, based on one or more sensors located on the output device, at least one of a temperature, pressure, or an electrical characteristic.

14. The method of claim 13, further comprising:
determining that the output device is being worn or held based on the detecting.

15. The method of claim 11, wherein the receiving input comprises:
receiving input from the output device via radio frequency (RF) communications, and wherein the outputting content comprises:
outputting content to the output device via RF communications.

16. A system, comprising:
a plurality of output devices; and
logic configured to:
identify an input from a first one of the plurality of output devices, the input indicating that the first output device is being worn or held, and
forward media to the first output device.

17. The system of claim 16, wherein the logic is further configured to:
receive voice input from a user identifying a media file, and
identify the media file based on the voice input.

18. The system of claim 16, wherein when identifying an input, the first output device is configured to:
detect one of a resistance, capacitance, pressure or temperature condition associated with the first output device.

19. The system of claim 16, wherein the plurality of output devices comprise at least two of a pair of video glasses, a pair of video goggles, an interactive watch, an interactive bracelet or a display screen.

20. The system of claim 16, wherein the first output device comprises a pair of video glasses and a second one of the plurality of output devices comprises a liquid crystal or light emitting diode based display screen.
